(19) United States
(12) Patent Application Publication
(10) Pub. No.: US 2002/0091564 A1
(43) Pub. Date: Jul. 11, 2002

(54) Method and system for enabling viewer polling and election of prospective parents in broadcast child adoption proceedings

(76) Inventor: Uri Geller, Berkshire (GB)

Correspondence Address: PAUL A. GUSS, PAUL A. GUSS ATTORNEY AT LAW, 775 S 23RD ST FIRST FLOOR SUITE 2, ARLINGTON, VA, 22202

(21) Appl. No.: 09/757,609

(22) Filed: Jan. 11, 2001

Related U.S. Application Data
(60) Provisional application No. 60/248,839, filed on Nov. 16, 2000.

(51) Int. Cl. G06F 17/60

(52) U.S. Cl. 705/12

(57) ABSTRACT

A child adoption proceeding is conducted in the form of a television game show and online media event, wherein couples compete against each other to win legal custody of the child. Adoptive parents are selected using a vote-by-phone and/or Internet voting scheme, together with 24-hour surveillance of the prospective parents, which enables television viewers and Internet users to inspect prospective parent-contestants in detail before voting for the winning parents. The present invention overcomes inequities of state-run or private adoption agencies, permitting a fairer selection process while providing greater time and access to observe a pool of prospective parents.

### CROSS-REFERENCE TO RELATED APPLICATIONS

This application claims priority from U.S. Provisional Application Serial No. 60/248839 filed on Nov. 16, 2000 by Uri Geller, the disclosure of which is incorporated herein by reference.

### BACKGROUND OF THE INVENTION

1. Field of the Invention

The present invention relates to a method and system for interactive entertainment using television or other video console equipment in association with a telecommunications network and client-server system for receiving and collecting input from viewers. The invention also concerns a system by which viewers, through online voting or using a vote-by-phone method, can participate in the selection process of prospective parents in a television broadcast adoption proceeding.

2. Description of the Related Art

Interactive television is known in which viewers are able to actively participate in the unfolding of a drama by voting, using the telephone, Internet or user-input devices which connect to a video console or are made available to viewers in a studio audience. With such systems, as the drama is unfolding on the television or stage, viewers are able to influence the progression of the drama at various stages during viewing. Votes from multiple users, which are received by telephone, Internet or other user-input devices, are collected, stored and tabulated. Based on the majority outcome of such voting, a particular plot change or ending to the drama is made.

Viewer participation by voting has also been used in game shows and so-called “reality television” episodes, such as the recently aired “Big Brother” series. In this series, 24-hour surveillance of competing contestants was made available to viewers over television. Viewers observed contestant behavior and interaction over several weeks, and using primarily a vote-by-phone method, elected the person they believed to be most deserving to receive a cash prize. The election process occurred at several stages during broadcast episodes, which transpired over several weeks, while contestants were gradually eliminated until an ultimate winner remained.

Adjudicative proceedings for child adoptions have been the source of criticism due to apparent inequities when it comes to selecting the most suitable parents for a child available for adoption. Further, demand by adoptive parents vastly outpaces the supply of newly born children available for adoption. As a result, prospective parents having greater financial means are sometimes chosen over parents who may possess stronger moral character. State-run adoption agencies are also less likely to grant adoptions to persons living so-called alternative lifestyles, such as unwed single males or gay and lesbian couples.

Private adoption agencies also operate by which only those prospective parents possessing the substantial financial resources needed to contract with such agencies are able to access a source of newly born children denied to otherwise deserving, but less wealthy, parents. Surrogate parenting or fertilization in vitro are yet other methods available to parents who cannot conceive children on their own, but similarly, access to such procedures strongly favors the wealthy.

When adoptive parents are chosen by bureaucrats, or when private adoption, surrogate or in vitro procedures are made available only to the wealthy, the concept of fairness in the selection process is open to question. Moreover, under the best of circumstances, the depth of contact and amount of time spent with prospective parents is highly limited.

Voting by viewer participation in media broadcast events has proven to yield justifiable and equitable results, as in the case of the “Big Brother” episode, where it was widely believed that the most deserving participant ended up the correct winner. Moreover, an audience polling system for the game program “Who Wants to be a Millionaire” has proven to be extremely accurate, rarely failing in cases where the contestant asks the audience to vote on a correct result to a question.

### SUMMARY OF THE INVENTION

A general object of the present invention is to provide a system and method for selection of adoptive parents using a vote-by-phone, Internet or other voting scheme, together with 24-hour surveillance of the prospective parents, which enables viewers and Internet users to inspect prospective parent-contestants in detail before voting for the winning parents.

In the context of the present invention and claims, the term “parent-contestant” shall refer to a prospective parental entity, which typically is a husband and wife couple, although this term also is construed to include same-sex unions, or even single individuals, who desire to become parents.

The present invention overcomes the inequities of state-run and private adoption procedures by 1) permitting a fairer selection process in which members of a viewing public can vote on the best capable parents, and 2) providing an abundance of time and access to observe a pool of prospective parents so that a truly fair and contemplative choice can be made.

### BRIEF DESCRIPTION OF THE DRAWINGS

FIG. 1 illustrates a system configuration for presenting media content over a combined Internet, CATV, satellite and/or broadcast television network, including a system for enabling viewer participation through upstream connections to the network, according to an embodiment of the present invention.

FIG. 2 illustrates a typical scenario by which votes may be collected and counted according to an embodiment of the present invention.

### DETAILED DESCRIPTION OF THE PREFERRED EMBODIMENTS

A narrative description of aspects and implications of this invention is to be presented in the form of an online electronic novel entitled “Nobody's Child” authored by the present inventor, Copyright© 2000 Uri Geller, all rights reserved. The beginning chapters of the novel form an appendix to Provisional Patent Application Serial No. 60/248839, the full disclosure of which is incorporated into the present specification by reference.

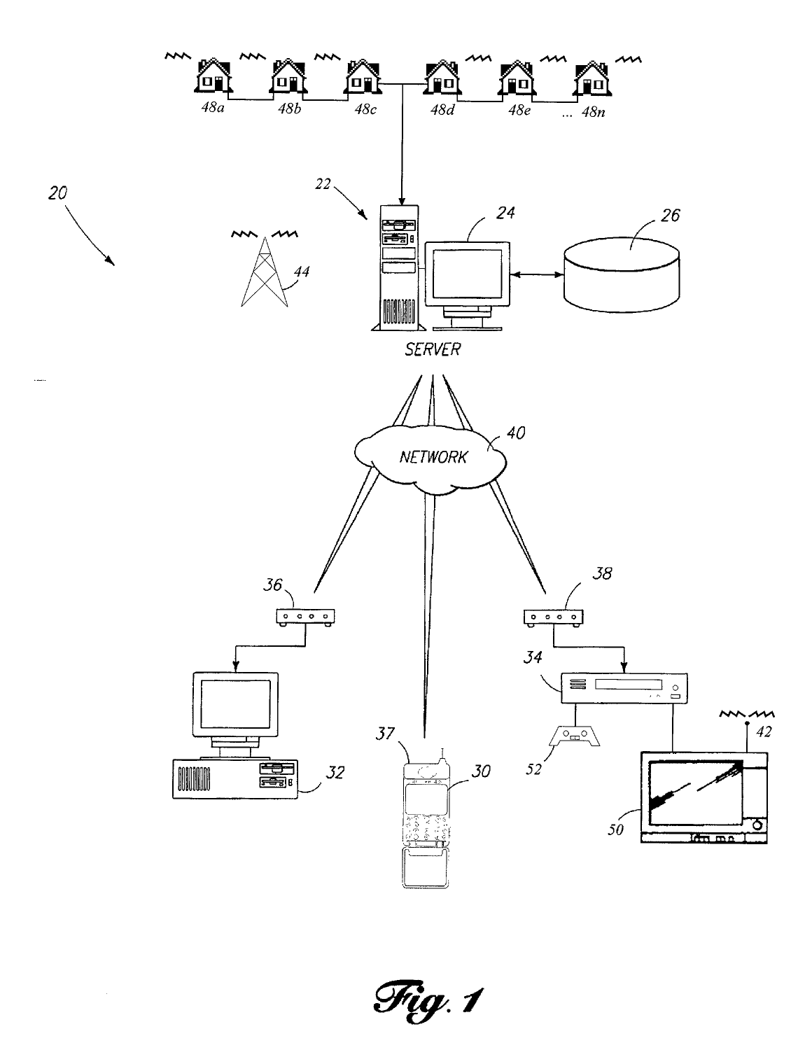

FIG. 1 is a diagrammatic illustration of an interactive client-server system 20 to which the teachings of the present invention are applied. More specifically, the system is constituted by a broadcast headend facility 22 with a server terminal 24 and associated file storage 26 for compiling tallies from viewer-participants, which are input to the server from any of various input devices such as conventional PSTN or wireless telephones 37, Internet-connected computers 32, PDAs (not shown) or set-top boxes 34 equipped with user-input controllers 40, for example.

Viewer receiving units are each equipped with some kind of digital communications capability, however, the units may be embodied as different types of devices. It shall be understood that devices which enable connections to the network 40 and allow upstream communications of data, particularly viewer votes, are usable in the context of the present invention.

Receiving units 32, 34, 37 connect to the server 24 via a network represented by network cloud 40. For upstream (server-directed) client input, the network 40 may be in the form of a wireless network, such as satellite and cellular phone networks, or a wire-based network, such as low-bandwidth telephone lines or higher-bandwidth cable or CATV networks, or any combination thereof. In addition, media content is supplied as downstream content to a television receiver 50 comprising a display, typically as a series of weekly episodes, by means of a CATV connection, satellite TV or television airwave broadcasts (airwave broadcasts are represented at 44), which also may be considered as forming part of the bi-directional network 40.

Typically, the desktop computer 32 and set-top appliance 34 will connect to the network 40 over modem devices 36, 38 which may be conventional or high-speed capable modems, or any other known connecting devices, such as wireless or satellite systems, for establishing connections to the network 40. Of particular interest to the present invention, however, are telephones 37 which establish a wireless or wire-based connection with the network 40 which enable viewer-participants to submit votes by using the telephone keypad.

Wireless telephones, which operate using the WAP or I-mode standard in which Internet functions, such as sending and receiving of email messages, along with viewing and interacting with Internet content via an integrated browser program and display screen 40 incorporated into the mobile telephone 37, may also be utilized, as may small handheld computing devices known as Portable Digital Assistants (PDAs) which also possess Internet functions and establish connections to the network 40 using wireless systems or modem lines.

A plurality of contestant households 48a through 48n also connect to the server by means of a closed-circuit network. Each house is equipped inside, and optionally around its outdoor vicinity, with multiple video cameras (not shown) and microphones (not shown) which can capture still or motion picture images and sounds to enable a 24-hour surveillance of the house and its occupants. Images and sounds are transmitted to the server facility either by wireless broadcast, or by a closed-circuit connection to the server, by any of known conventional methods and formats, such as the MPEG-3 standard.

After arriving at the headend facility, the images and sounds can be edited and presented as part of a weekly-aired television program, which is transmitted publicly to multiple television receivers 50 over broadcast airwaves (see 44, 42) or through conventional CATV or satellite systems.

Concurrently with the weekly-aired program, still or short-clip moving images and audio, along with synopses, parent biographies or other supplementary textual material, can be presented in the form of HTML Internet web pages, prepared and stored in storage facility 26, and which are made accessible to viewers connected to the Internet using a personal computer 32 or other web-enabled device such as a WAP or I-mode telephone 37. Internet applications embodied in Java applets, Javascript controls, CGI scripts, and the like, can be provided as part of such web pages, for enabling viewers to make online votes, which are compiled and tabulated along with votes received by telephone 37 or through the user-input device 52. Selection of prospective parent-contestants can be made at any time of the day, or if desired, during set time periods established by the television program, by any of these available methods.

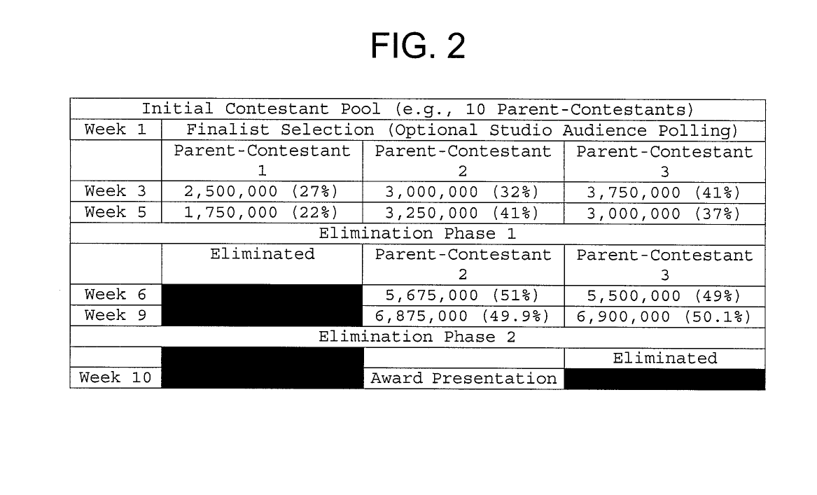

A basic system configuration for the invention has been described above. Next, a description shall be provided of operations of the system to provide an interactive media event by which prospective adoptive parents are voted on to determine the best eligible parent or parents for a child. Although the invention is not limited to this description, a typical scenario for a 10 week television series is shown in FIG. 2, over which votes are collected from viewers and tabulated for each of respective parent-contestants.

As a first step to initiating the selection process, a plurality of prospective couples or single parents from various walks of life are selected to make up a pool of prospective parent-contestants. Parent-contestants are chosen by entities working for or in association with the server entity based on various criteria determined through auditions, questionnaires, consideration of parent-submitted essays, and the like. The selection process is conducted to provide a pool of qualified applicants, any of whom would meet legal and moral standards sufficient for parenting a newborn child.

The available child (or children) will have been provided through legal and/or contractual means to the temporary custody of individuals or entities working in association with the server entity, with the understanding that once a winner from among the parent-contestants has been selected, the child will be transferred to the custody of the winning parent or parents, with any necessary legalization or officiating of the transfer being conducted according to existing laws of the jurisdiction.

Then, for example, during the first week of the program, viewers will be permitted to vote on finalists (in the illustration, three parent-contestants are chosen as finalists) from among a larger pool of parents, for example, ten participating couples. During the first segment of the program, the studio audience may also be polled on their choices for finalists. The studio audience vote may displayed on screen for television or Internet viewers, although this vote may or may not be calculated in with votes from the television or Internet viewing audience. That is, the studio audience vote can serve to stimulate or encourage a viewer's own opinions, in favor of or against one or more of the parent-applicants. Preferably, during airing of the first episode in week 1, a given time period is opened up during which viewers can elect using a vote-by-phone method or/and by voting using an Internet-based application presented in web-based content, accessible by PC 32, and the votes are tabulated in real-time so that three finalist parent-contestants will be revealed during airing of the first program.

Preferably over a series of several weeks, live and still images of the finalists (in this example, three parent-contestants are shown) are presented on the display unit 50, along with biographical sketches, audio clips and so forth. Salient among such video and audio sources are live broadcast sequences transmitted from each of the parent-contestants' homes 48a - 48n, each of which is equipped with multiple internal and/or external cameras and microphones that provide a 24-hour surveillance capability.

The video and audio transmissions from each of homes 48a 48n are made available to viewers by two routes: broadcast television programs and over the Internet as HTML content. In the case of broadcast television programs, typically the transmissions will be collected by a production staff working in association with the server entity to prepare a weekly television series, which focuses on various aspects of the parent-contestants' lives, including not only live or pre-recorded shots from contestants' homes, but also any of interviews, reporter analyses, panel or audience discussions and so forth, in order to provide a complete picture of the eligibility of the contestants to viewers who watch the television series.

Concurrently with the television series, multimedia Internet content is provided to viewers who log on to a web site which complements the television series, and which contains more in-depth information, particularly written information, on the contestants than is possible for presentation in a weekly television series. The Internet content may also provide 24-hour online access to live streaming video and audio (MPEG-3, MP3, Real Audio, etc.) which is transmitted to the server from the cameras and microphones placed in each of the households 48a-48n, and the server makes such content available to Internet users who can log on at any time to observe the behavior and lifestyles of the competing prospective parents. Optionally, contestants themselves could be equipped with portable video cameras or microphones which transmit content wirelessly to the server facility, the content being made available for viewing/consumption by Internet users. Camera and microphones may also be provided in restaurants or other public meeting places that the parent-contestants may visit from time to time.

Along with images of the parent-contestants, images and multimedia presentations of the child available for adoption are also presented on the television display 50 and over the Internet on personal computer 32. This better enables viewers and Internet users to make judgements about the suitability of each of the parent-contestants for the particular child. Alternatively, in order to pique viewer interest, certain details about the child (such as its race or gender) may be left unknown.

Votes may be collected and tabulated for the parent-contestants over the remaining weeks. Voting can be restricted to time periods during which the program is aired, or alternatively, voting can be collected on a continual basis using vote-by-phone or Internet voting, as has been previously described. The amount of final votes for each parent-contestant can also optionally be supplemented or weighted by “bonus points” which are won by the competing parent-contestants for performing certain games or tasks during airing of the program. In either case, after the end of a certain time period (as shown, at week 5) the parent-contestant receiving the fewest percentage votes and/or bonus points is eliminated from the pool, thereby leaving two finalists.

It is of course possible, depending on how a question is phrased, that the votes may be tabulated in such a way as to have a negative affect on the parent-contestant receiving the most votes. More specifically, viewers could be asked to vote for the parent-contestant (s) they believe should be eliminated from the pool. In this case (not shown), the parent-contestants receiving the most votes would be eliminated, rather than remain, in the pool.

Similar procedures, involving viewer voting over telephones or the Internet, along with optional games or tasks for awarding bonus points to the remaining contestants, are conducted over the remaining weeks (as shown, weeks 6-9) of the program, until a winning parent-contestant is selected. Then, in a final week of the program (e.g., week 10) an awards presentation may be aired in which the winning parents are revealed to the public and are presented with the adoptive child.

The above descriptions are illustrative of possible embodiments of the invention. However, it shall be understood that various modifications will be apparent and can be easily made by persons skilled in the art without departing from the scope and spirit of the present invention. Accordingly, the following claims shall not be limited by the descriptions or illustrations set forth herein, but shall be construed to cover with reasonable breadth all features which may be envisioned as equivalents by those skilled in the art.

The present invention may be applied to one or more of television, cable, satellite, Internet, or any other media distribution systems currently in existence or to be developed, or any combination of such media types.

What is claimed is:

1. A method for selecting adoptive parents, comprising:
providing a plurality of parent-contestants;
displaying, on a receiving unit comprising a video display, an image of at least one of said parent-contestants;
transmitting selections from a plurality of viewers to a server facility over a communications network;
compiling said selections transmitted over said communications network for each of said parent-contestants; and
awarding at least one child available for adoption to at least one winning parent-contestant.

2. The method according to claim 1, further comprising displaying, on said receiving unit, at least one image of a child available for adoption;

3. The method according to claim 1, wherein said image of at least one parent-contestant is displayed as a function of time.

4. The method according to claim 1, wherein said selections comprise choices for at least one of:
a) eliminating a parent-contestant from a pool, and
b) selecting a parent-contestant to remain in said pool.

5. The method according to claim 1, wherein said selections include comments.

6. The method according to claim 5, further wherein said comments comprise extemporaneous narrative and/or pre-selected narrative.

7. The method according to claim 1, wherein the selections are supplemented by bonus points.

8. The method according to claim 7, further wherein said points are awarded to the parent-contestants based upon the performance of specified games or tasks.

9. The method according to claim 1, wherein the parent-contestant receiving the greatest number of selections is either eliminated from a pool or selected to remain in said pool.

10. The method according to claim 1, wherein said selections are made intermittently or periodically.

11. The method according to claim 1, wherein said compiling is performed either intermittently or periodically.

12. The method according to claim 4, wherein said viewers are presented with the opportunity to change their selections after a specified period of time and or the occurrence of a specified event.

13. The method according to claim 1, wherein said parent-contestants are subject to surveillance on an intermittent, periodic, continuous and or on-demand basis.

14. The method according to claim 1, wherein information is presented on the display screen of said receiving unit.

15. The method according to claim 14, further wherein said information includes at least one of graphical, video and audio data.

16. A system for selecting adoptive parents, comprising:
a communications network for transmitting selections from a plurality of viewers;
a broadcast headed facility having a server for compiling said selections transmitted over said communications network for a plurality of parent-contestants;
a file storage device;
a least one viewer input device;
a receiving unit comprising a video display for displaying an image of at least one said parent-contestants;

17. The system according to claim 16, further comprising a receiving unit comprising a video display for displaying at least one image of a child available for adoption;

18. The system according to claim 16, wherein said at least one input device includes at least one of a telephone, computer, portable digital assistant, set-top box and user-input controller.

19. The system according to claim 16, further comprising a parent-contestant surveillance device.

20. The system according to claim 18, wherein said surveillance device is a closed circuit and or distributed network.

21. The system according to claim 19, wherein said device is portable.

22. The system according to claim 20, further wherein said portable device is wirelessly coupled to said headend facility.
